(19) United States
(12) Patent Application Publication
(10) Pub. No.: US 2018/0244589 A1
(43) Pub. Date: Aug. 30, 2018

(54) Fertilizer with Organic Potassium Salts

(71) Applicant: Nachurs Alpine Solutions, Corp., Marion, OH (US)

(72) Inventors: Tommy Roach, Lubbock, TX (US); Gregory Bame, Marion, OH (US)

(73) Assignee: Nachurs Alpine Solutions, Corp., Marion, OH (US)

(21) Appl. No.: 15/753,116

(22) PCT Filed: Sep. 2, 2016
(86) PCT No.: PCT/US16/50121

§ 371 Date: Feb. 15, 2018

Related U.S. Application Data
(60) Provisional application No. 62/213,742, filed on Sep. 3, 2015.

(51) Int. Cl. C05C 3/00; C05C 9/00; C05D 9/02; C05D 1/00; C05B 7/00; C05B 17/00; C05F 11/08; C07F 1/06

(52) U.S. Cl. CPC C05C 3/005; C05C 9/00; C05D 9/02; C07F 1/06; C05B 7/00; C05B 17/00; C05F 11/08; C05D 1/005

(57) ABSTRACT

The present invention provides a new fertilizer comprising a nitrogen source, a phosphate source, and an organic potassium source selected from the group consisting of potassium acetate, potassium formate, potassium citrate, potassium succinate, potassium propionate, animal manure, and combinations thereof. The fertilizer has a neutral to slightly alkaline pH, relatively lower salt index and potentially lower phytotoxicity damage compared to other sources of potassium for fertilizer products. The fertilizer composition may further comprise additives such as sulfur, zinc, boron, calcium, manganese, iron, copper, cobalt, magnesium, or a combination thereof.

### CROSS-REFERENCE TO PRIOR APPLICATIONS

The present application claims priority to U.S. Patent Application 62/213,742 filed 2015 Sep. 3, currently pending, which is incorporated by reference in its entirety.

### FIELD OF THE INVENTION

The invention relates to a plant fertilizer product comprising soluble nitrogen, a phosphate source, an organic potassium source, and optionally metals selected from the group consisting of sulfur, zinc, boron, calcium, manganese, iron, copper, cobalt, magnesium, or a combination thereof. The fertilizer is provided as a low salt, essentially neutral pH solution which can be applied via known irrigation methods.

### BACKGROUND OF THE INVENTION

In order to maintain healthy growth, plants must extract a variety of nutrients from the soil in which they grow. However, many soils are deficient in the necessary nutrients or the soils contain them only in forms which cannot be readily taken up by plants. To counteract these deficiencies, commercial fertilizing products containing select nutrients are commonly applied to soils in order to improve growth rates and yields obtained from crop plants. For example, potassium may be added to soil to counteract a lack of available potassium.

Fertilizers come in two basic forms, liquid and dry. Liquid fertilizers have gained commercial approval mainly due to the ease of handling and application. However, for a liquid fertilizer to become a commercially viable product, it must have a relatively high nutrient analysis. Ideally, it also should be able to blend with other liquid fertilizers to supply the required nutrients for a growing crop.

Potassium is normally required by a growing plant to stimulate early growth, to increase protein production, and to activate beneficial enzyme and hormone systems within the plant. These systems impact the plant's ability to withstand biotic and abiotic stress, and extreme cold and hot temperatures, and improves the plant's resistance to diseases and insects. Further, potassium increases water use efficiency and transforms sugars to starch.

The typical potassium sources for fertilizers are inorganic potassium salts, such as potassium chloride (potash), potassium magnesium sulfate, potassium nitrate, and potassium sulfate. However, the inorganic anions found in these salts can have damaging effects on the environment. Thus, it would be beneficial to have an environmentally-friendly potassium source for fertilizer products.

### SUMMARY OF THE PRESENT INVENTION

A new fertilizer comprising soluble nitrogen, a phosphate source and an organic potassium source, wherein the fertilizer has a neutral to slightly alkaline pH and a relatively low salt index is described. In a preferred embodiment, the potassium source or potassium nutrient component is derived from potassium phosphate, organic sources of potassium, animal manure, carboxylic acid salts of potassium, potassium silicate and combinations thereof. Because of the lower salt index and the absence of inorganic anions delivered with the potassium, the fertilizer composition of the present invention may demonstrate lower phytotoxicity damage compared to other sources of potassium for fertilizer products. Optionally, the fertilizer composition may include additives known in the art, such as sulfur, zinc, boron, calcium, manganese, iron, copper, cobalt, magnesium, or a combination thereof.

The fertilizer composition of the present invention is intended to be used in all cropping rotations and management practices where it can be placed in-furrow at planting, injected into the soil, surface dribbled in a band, sprayed between crop rows, or broadcast, foliar or fertigation applied to meet the crops' potassium requirements. The fertilizer is intended to be used on any potassium-requiring crops, such as but not limited to, corn, soybeans, wheat, alfalfa, sugar beets, potatoes, grapes, onions, peppers, lettuce, beans, celery, cauliflower, broccoli, pumpkins, nectarines, tomatoes, other fruits and vegetables, and pulse crops.

### DETAILED DESCRIPTION OF THE PRESENT DEVELOPMENT

The present development is a composition for a commercial fertilizer product that is intended to be applied in hard water regions by irrigation methods, including but not limited to subsurface drip, drip tape, micro-jet, center pivot, surface drip, flood, and sprinkler. The present development is a fertilizer comprising soluble nitrogen, a phosphate source, and an organic potassium source, and optionally comprising metal additives selected from the group consisting of a sulfur source, a zinc source, a boron source, a calcium source, a manganese source, an iron source, a copper source, a cobalt source, a magnesium source, or a combination thereof. The fertilizer of the present development has a neutral to slightly alkaline pH and a relatively low salt index compared to other sources of potassium for fertilizer products.

The fertilizer composition of the present application may be used in any environment, but is particularly suitable for application in areas known for having hard water. For the purposes of this application, “water hardness” is defined as the amount of dissolved calcium and magnesium in the water, and “hard water” is defined as water having a water hardness equal to or greater than 120 ppm or water having a calcium ion concentration [Ca²⁺] plus magnesium ion concentration [Me²⁺] equal to or greater than 120 ppm.

The nitrogen source may be any soluble nitrogen source known in the art for fertilizer use, such as urea, nitrate, triazone urea, urea triazone solution, ammonia, ammonium salts, ammonium hydroxide, amino acids, fish meal or extract, compost extract, kelp extract, shrimp extract, shellfish extract, and combinations thereof. In a preferred embodiment, the soluble nitrogen source is essentially non-reactive with common hard water components—that is, when the nitrogen source is exposed to hard water it does not react to form insoluble particulates or precipitates. The concentration of the soluble nitrogen source will vary depending on the source selected, but the resulting available nitrogen in the final composition should be up to about 20%, and is more preferably from about 1.5% to about 12.0%.

The phosphate source is selected from the group consisting of rock phosphate, sodium phosphate, potassium phosphate, phosphoric acid, bone meal, monopotassium phosphate, dipotassium phosphate, tetrapotassium pyrophosphate, ammonium phosphate, calcium phosphate, and combinations thereof. Preferably, the phosphate source further includes at least one source of orthophosphate. In a preferred embodiment, the phosphate source is phosphoric acid. In a more preferred embodiment, the phosphate source is a phosphoric acid solution having a pH<6.0. In a most preferred embodiment, the phosphate source is a 60% to 85% phosphoric acid solution and the final product should have a pH between 5.5 and 6.3. The phosphate source may vary, thereby affecting the amount needed in the composition, but the resulting available phosphorus in the final composition should be from about 0% to about 25%. If an orthophosphate is used, the orthophosphate content should be no less than 50%. Because of their reactivity, it is recommended that polyphosphates, and particularly those made from super phosphoric acid, not be used or be minimized in any composition of the present development.

The organic potassium source may be any potassium salt with a carbon-based counterion that is water soluble, and preferably that is essentially non-reactive with common hard water components—that is, when the potassium source is exposed to hard water it must not react to form insoluble particulates or precipitates. Representative potassium sources include potassium hydroxide, potassium phosphate, animal manure, carboxylic acid salts of potassium, potassium silicate and combinations thereof. The carboxylic acid salts of potassium anticipated by this invention include (1) HCOOK, or (2) CH₃(CH₂)ₓCOOK wherein x=0-4, or (3) MOOC(CR¹R²)ₓCOOK wherein R¹═—H or —OH or —COOM and R²═−H or —OH or —COOM and x=0−4 and M=H or K, or (4) HO(CR¹R²)ₓCOOK wherein R¹═H or a C1 to C4 alkyl group and R²═H or a C1 to C4 alkyl group and x=1-5, or (5) CH₃CO(CR¹R²)ₓCOOK wherein R¹═H or a C1 to C4 alkyl group and R²═H or a C1 to C4 alkyl group and x=1-3. Exemplary carboxylic acid salts of potassium as defined herein include potassium formate, potassium acetate, potassium propionate, potassium butyrate, potassium valerate, potassium hexanoate, potassium oxalate, potassium malonate, potassium succinate, potassium glutarate, potassium adipate, potassium lactate, potassium malate, potassium citrate, potassium glycolate, potassium tartrate, potassium glyoxylate, and potassium pyruvate. In a preferred embodiment, the potassium source is selected from potassium acetate, potassium formate, potassium citrate, potassium succinate, potassium propionate, animal manure, and combinations thereof. In a more preferred embodiment, potassium acetate is used. The resulting available potassium in the form of K₂O in the final composition should be from about 1.0 wt % to about 60 wt %, and is more preferably from about 14 wt % to about 25 wt %. Further, it is recommended that the potassium source selected and the amount added to the composition should provide a buffering function to the composition and maintain the pH between 5.5 and 10.5, and more preferably between 7.0 to 9.3.

Optionally, the fertilizer may further comprise a secondary nutrient at a concentration of from 0.0 wt % to about 25.0 wt %, and more preferably from about 0.2 wt % to about 10.0 wt %, wherein the secondary nutrient is derived from a sulfur source, a zinc source, a boron source, a calcium source, a manganese source, an iron source, a copper source, a cobalt source, a magnesium source, or a combination thereof. Sources of secondary nutrients are well known in the art. Some representative examples, without limitation, include potassium thiosulfate, ammonium thiosulfate, zinc ethylenediaminetetraacetic acid (ZnEDTA), calcium ethylene-diaminetetraacetic acid (CaEDTA), ammonium calcium nitrate, manganese ethylenediaminetetraacetic acid (MnEDTA), iron ethylenediaminetetraacetic acid (FeEDTA), iron N-(hydroxyethyl) ethylene-diaminetriacetic acid (FeHEDTA), iron ethylenediamine-N, N¹-bis (2-hydroxyphenylacetic acid) (FeEDDHA), iron ethylene-diamine-di (2-hydroxy-5-sulfophenylacetic acid) (FeEDDHSA), cobalt ethylenediaminetetraacetic acid (CoEDTA), cobalt sulfate, magnesium ethylenediaminetetraacetic acid (MgEDTA), ethylene-diaminetetraacetic acid (CuEDTA), sodium borate, disodium octaborate tetrahydrate, boric acid, and combinations thereof. Other additives, such as a poly-aspartic acid or amino polycarboxylic acid or a combination thereof, may also be included in the composition.

Optionally, an inoculant may further be included in the composition. The inoculant may comprise any of a number of organisms or beneficial microbes. These include those strains designated as bacillus subtilis, bacillus methylotrophicus, bacillus amyloliquefasciens, bacillus megaterium and bacillus licheniformis, and combinations thereof. Preferably the strains selected for the composition comprise bacillus subtilis PB 038, bacillus subtilis PB 346, bacillus methylotrophicus PB 105, bacillus methylotrophicus PB 302, bacillus amyloliquefasciens PB 178, bacillus amyloliquefasciens PB 390, bacillus megaterium PB 208 and bacillus licheniformis PB 035, wherein each bacillus subtilis, bacillus methylotrophicus, bacillus amyloliquefasciens, and bacillus megaterium strain is added to deliver from about 3×10⁶ cfu/mL to about 7×10⁶ cfu/mL, and the bacillus licheniformis is added to deliver from about 3×10⁴ cfu/mL to about 7×10⁴ cfu/mL. Optionally, other beneficial organisms, as desired to deliver microbial protective benefits to the crop, may be included in the composition.

Water is added to balance the composition.

The following exemplary embodiments, not intended to be limiting with respect to scope of the development, are prepared by slowly adding to water the other composition ingredients, and then mixing at ambient temperature for at least 60 minutes ensuring that the temperature is held below 50° C. The solution is then filtered through a 10 micron filter before packaging. If inoculants are included in the composition, order of addition, residence times, and mixing temperatures may need to be adjusted to ensure viability of the inoculant.

TABLE I

| | | | | | | | | Secondary |
|---|---|---|---|---|---|---|---|---|
| | Nitrogen | Available N | Phosphate | Available P | Potassium | Available K | Secondary | Nutrient |
| Sample | Source | (wt %) | Source | (wt %) | Source | (wt %) | Nutrient | (wt %) |
| A | — | 0 | — | 0 | K-succinate | 15.0 | ZnEDTA | 2.7 |
| B | urea | 2.0 | phosphoric | 6.0 | K-acetate + | 16.0 | — | 0 |
| | | | acid | | KOH | | | |
| C | urea + NH₄OH | 5.0 | ortho- | 12.3 | K-acetate + | 5.0 | K₂S₂O₃ | 2.7 |
| | | | phosphate | | K₂S₂O₃ | | ZnEDTA | 0.8 |
| D | urea + | 8.0 | phosphoric | 4.0 | K-acetate + | 6.0 | BNa₃O₃ | 0.1 |
| | ammonium | | acid | | KOH | | CuEDTA | 0.2 |
| | polyphosphate | | | | | | MnEDTA | 1.0 |
| | | | | | | | ZnEDTA | 1.0 |
| E | urea + urea- | 21.0 | phosphoric | 1.0 | K-acetate + | 3.0 | — | 0 |
| | triazone | | acid | | KOH | | | |
| F | NH₄OH | 2.0 | — | 0 | K-formate | 20.0 | FeEDDHSA | 6.3 |
| | | | | | | | CoEDTA | 1.8 |
| | | | | | | | MgEDTA | 0.9 |
| G | NH₄OH | 3.2 | ortho- | 10.0 | K-acetate + | 13.4 | K₂S₂O₃ | 0.2 |
| | | | phosphate | | K₂S₂O₃ | | FeHEDTA | 2.6 |
| H | urea + NH₄OH | 7.0 | phosphoric | 20.0 | K-acetate + | 4.0 | — | 0 |
| | | | acid | | KOH | | | |
| I | urea | 10.0 | phosphoric | 10.0 | K-malate + | 10.0 | K₂S₂O₃ | 8.5 |
| | | | acid | | K₂S₂O₃ | | | |
| J | urea + NH₄OH + | 9.0 | phosphoric | 15.0 | K-acetate + | 3.0 | (NH₄)₂S₂O₃ | 1.0 |
| | (NH₄)₂S₂O₃ | | acid | | KOH | | ZnEDTA | 0.25 |
| K | urea | 5.9 | ortho- | 24.0 | K-lactate | 6.3 | MnEDTA | 5.4 |
| | | | phosphate | | | | | |
| L | — | 0 | — | 0 | K-acetate | 24.0 | — | 0 |
| M | ammonium | 2.0 | phosphoric | 8.0 | K-acetate + | 11.0 | K₂S₂O₃ | 1.0 |
| | polyphosphate | | acid | | K₂S₂O₃ + KCl | | | |
| N | urea + NH₄OH + | 4.0 | phosphoric | 13.0 | K-acetate + | 17.0 | (NH₄)₂S₂O₃ | 1.0 |
| | (NH₄)₂S₂O₃ | | acid | | KOH | | | |
| O | urea + NH₄OH | 10.0 | phosphoric | 18.0 | K-acetate + | 4.0 | — | 0 |
| | | | acid | | KOH | | | |
| P | — | 0 | — | 0 | K-acetate + | 19.0 | K₂S₂O₃ | 6.0 |
| | | | | | K₂S₂O₃ | | | |
| Q | urea + NH₄OH | 7.0 | ortho- | 19.8 | K-acetate + | 4.2 | K₂S₂O₃ | 2.7 |
| | | | phosphate | | K₂S₂O₃ | | ZnEDTA | 0.8 |
| R | NH₄OH + urea- | 2.0 | — | 0 | K-acetate + | 20.0 | K₂S₂O₃ | 8.0 |
| | triazone | | | | KOH + | | BNa₃O₃ | 0.2 |
| | | | | | K₂S₂O₃ | | CaEDTA | 0.1 |
| | | | | | | | ZnEDTA | 0.45 |
| S | urea + NH₄OH + | 3.0 | phosphoric | 10.0 | K-acetate + | 13.0 | (NH₄)₂S₂O₃ | 1.0 |
| | (NH₄)₂S₂O₃ | | acid | | KOH | | ZnEDTA | 0.1 |
| T | urea | 8.0 | ortho- | 15.0 | K-formate | 3.0 | CaEDTA | 1.4 |
| | | | phosphate | | | | CuEDTA | 6.8 |
| U | urea | 7.5 | ortho- | 10.0 | K-formate | 3.0 | CaEDTA | 1.4 |
| | | | phosphate | | | | CuEDTA | 6.8 |

Urea-triazone refers to a urea triazone solution
K-{organic anion} refers to the potassium salt of the organic anion, e.g. K-succinate is potassium succinate
BNa₃O₃ is generically used in Table I to refer to all forms of Sodium Borate

The organic potassium source fertilizer (hereinafter referred to as “KOrg-fertilizer”) is preferably used for fertilizing agricultural crops. The KOrg-fertilizer may be applied by a variety of methods, along with other fertilizers or pesticides or by itself, such as: as a starter or other fertilizer, as an in-furrow treatment, as a foliar fertilizer, as a side-dressed treatment after planting, or as a soil injected fertilizer. The KOrg-fertilizer may be used in no-tillage and minimal tillage conditions where it can be injected into the soil, surface dribbled in a band, sprayed between crop rows, or broadcast applied to meet the crops' potassium requirements. The KOrg-fertilizer can be applied with herbicides to reduce the number of trips over the field thus saving time, fuel and reducing soil compaction. Some recommended means of application, not intended to limit the scope of the claims, include in-furrow application, foliar application, side-dress treatment after planting, pre-planting soil injection, broadcast application, banding 2×2, fertigation, subsurface drip, drip tape, micro-jet, center pivot, surface drip, flood, sprinkler, and combinations thereof.

The KOrg-fertilizer is beneficial for fertilizing all potassium-requiring crops. Non-limiting examples of crops which may be treated with the KOrg-fertilizer of the invention include corn, soybeans, wheat, alfalfa, sugar beets, potatoes, grapes, onions, peppers, lettuce, beans, celery, cauliflower, broccoli, pumpkins, nectarines, tomatoes, other fruits and vegetables, and pulse crops. As is known in the art, the KOrg-fertilizer is applied at different rates or amounts depending upon the particular crop and the method of fertilization.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. The term “ambient temperature” as used herein refers to an environmental temperature of from about 0° F. to about 120° F., inclusive.

As used herein, the specified terms are defined as follows: (1) “NPK” is an abbreviation for a composite fertilizer containing one or more sources of nitrogen (N), phosphorus (P in the form of P₂O₅) and/or potassium (K in the form of K₂O) at the wt % designated by the specific placeholder N—P—K; (2) “starter fertilizer” is a fertilizer applied in low doses close to the plant seed used to promote the growth of newly planted crops, particularly newly germinated seeds; (3) “banded fertilizer” is a fertilizer applied in low doses along the side of the seed row and either on the surface or below the seed row; (4) “in-furrow application” refers to the process of placing fertilizers directly with the seed during planting; (5) “top-dress” refers to broadcast applications on crops like small grains; (6) “side dress” refers to fertilizer placed at relatively high amounts anywhere from three to four inches from the row to half way between the crop rows; (7) “foliar application” refers to the process of applying liquid fertilizer directly to the leaves of a plant; (8) “broadcast application” refers to a uniform distribution of material on the soil surface; and, (9) “fertigation” refers to the injection of fertilizer into an irrigation system.

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise.

It is understood that, in light of a reading of the foregoing description, those with ordinary skill in the art will be able to make changes and modifications to the present invention without departing from the spirit or scope of the invention, as defined herein. For example, those skilled in the art may substitute materials supplied by different manufacturers than specified herein without altering the scope of the present invention.

What is claimed is:

1. A fertilizer composition comprising a nitrogen source, a phosphate source, and an organic potassium source, wherein the organic potassium source is selected from the group consisting of potassium phosphate, organic sources of potassium, animal manure, carboxylic acid salts of potassium, potassium silicate and combinations thereof, and wherein the nitrogen source provides from 0.0% to 20% available nitrogen in the final composition, and the phosphate source provides from 0% to 25% available phosphate in the form of P₂O₅, and the potassium source provides from 1% to about 60% available potassium in the form of K₂O.

2. The fertilizer composition of claim 1 wherein the nitrogen source, the phosphate source and the organic potassium source are essentially non-reactive with calcium ions or magnesium ions.

3. The fertilizer composition of claim 1 wherein the nitrogen source is selected from the group consisting of urea, nitrate, triazone urea, ammonia, ammonium salts, ammonium hydroxide, amino acids, fish meal or extract, compost extract, kelp extract, shrimp extract, shellfish extract, and combinations thereof.

4. The fertilizer composition of claim 1 wherein the phosphate source is selected from the group consisting of rock phosphate, sodium phosphate, potassium phosphate, phosphoric acid, bone meal, monopotassium phosphate, dipotassium phosphate, tetrapotassium pyrophosphate, ammonium phosphate, calcium phosphate, and combinations thereof.

5. The fertilizer composition of claim 5 wherein the phosphate source includes at least one source of orthophosphate.

6. The fertilizer composition of claim 1 wherein the carboxylic acid salt of potassium is selected from (1) HCOOK, or (2) CH₃(CH₂)ₓCOOK wherein x=0-4, or (3) MOOC(CR¹R²)ₓCOOK wherein R¹═—H or —OH or —COOM and R²═—H or —OH or —COOM and x=0-4 and M=H or K, or (4) HO(CR¹R²)ₓCOOK wherein R¹═H or a C1 to C4 alkyl group and R²═H or a C1 to C4 alkyl group and x=1-5, or (5) CH₃CO(CR¹R²)ₓCOOK wherein R¹═H or a C1 to C4 alkyl group and R²═H or a C1 to C4 alkyl group and x=1-3.

7. The fertilizer composition of claim 8 wherein the carboxylic acid salt of potassium is selected from the group consisting of potassium formate, potassium acetate, potassium propionate, potassium butyrate, potassium valerate, potassium hexanoate, potassium oxalate, potassium malonate, potassium succinate, potassium glutarate, potassium adipate, potassium lactate, potassium malate, potassium citrate, potassium glycolate, potassium tartrate, potassium glyoxylate, potassium pyruvate, and combinations thereof.

8. The fertilizer composition of claim 9 wherein the carboxylic acid salt of potassium is selected from the group consisting of potassium formate, potassium acetate, potassium propionate, potassium lactate, potassium malate, potassium citrate, potassium tartrate, potassium pyruvate, and combinations thereof.

9. The fertilizer composition of claim 1 wherein the fertilizer composition has a pH of about 5.5 to about 10.5.

10. The fertilizer composition of claim 1, wherein the potassium source provides from 1% to about 25% available potassium in the form of K₂O.

11. The fertilizer composition of claim 1 further comprising from 0 wt % to 25 wt % of a secondary nutrient selected from the group consisting of sulfur, zinc, boron, calcium, manganese, iron, copper, cobalt, magnesium, or a combination thereof.

12. The fertilizer composition of claim 11 wherein the secondary nutrient is derived potassium thiosulfate, ammonium thiosulfate, zinc ethylenediaminetetraacetic acid (ZnEDTA), calcium ethylene-diaminetetraacetic acid (CaEDTA), ammonium calcium nitrate, manganese ethylene-diaminetetraacetic acid (MnEDTA), iron ethylenediaminetetraacetic acid (FeEDTA), iron N-(hydroxyethyl) ethylene-diaminetriacetic acid (FeHEDTA), iron ethylenediamine-N, N¹-bis (2-hydroxyphenylacetic acid) (FeEDDHA), iron ethylene-diamine-di (2-hydroxy-5-sulfophenylacetic acid) (FeEDDHSA), cobalt ethylenediaminetetraacetic acid (CoEDTA), cobalt sulfate, magnesium ethylenediaminetetraacetic acid (MgEDTA), ethylene-diaminetetraacetic acid (CuEDTA), sodium borate, disodium octaborate tetrahydrate, boric acid, and combinations thereof.

13. The fertilizer composition of claim 1 further comprising poly-aspartic acid or amino polycarboxylic acid or a combination thereof.

14. The fertilizer composition of claim 1 further comprising an inoculant selected from the strains designated as bacillus subtilis, bacillus methylotrophicus, bacillus amyloliquefasciens, bacillus megaterium and bacillus licheniformis, and combinations thereof.

15. The fertilizer composition of claim 1 wherein the composition is applied by in-furrow application, foliar application, side-dress treatment after planting, pre-planting soil injection, broadcast application, banding 2×2, fertigation, subsurface drip, drip tape, micro-jet, center pivot, surface drip, flood, sprinkler, and combinations thereof.

16. The fertilizer composition of claim 15 wherein the composition is used on a crop selected from the group consisting of corn, soybeans, wheat, alfalfa, sugar beets, potatoes, grapes, onions, peppers, lettuce, beans, celery, cauliflower, broccoli, pumpkins, nectarines, tomatoes, other fruits and vegetables, and pulse crops, and combinations thereof.

17. A fertilizer composition consisting essentially of:
a. a nitrogen source which delivers from 0.0% to 20% available nitrogen in the final composition;
b. a phosphate source which delivers from 0% to 25% available phosphate in the form of P₂O₅ in the final composition;
c. an organic potassium source which delivers from 1% to 60% available potassium in the form of K₂O in the final composition, and wherein the organic potassium source is selected from the group consisting of potassium phosphate, organic sources of potassium, animal manure, carboxylic acid salts of potassium, potassium silicate and combinations thereof; and,
d. 0% to 25% sulfur, zinc, boron, calcium, manganese, iron, copper, cobalt, magnesium, poly-aspartic acid, amino polycarboxylic acid, an inoculant, or a combination thereof.

18. The fertilizer composition of claim 17 wherein the nitrogen source selected from the group consisting of urea, nitrate, triazone urea, urea triazone solution, ammonia, ammonium salts, ammonium hydroxide, amino acids, fish meal or extract, compost extract, kelp extract, shrimp extract, shellfish extract, and combinations thereof.

19. The fertilizer composition of claim 17 wherein the phosphate source is selected from the group consisting of rock phosphate, sodium phosphate, potassium phosphate, phosphoric acid, bone meal, monopotassium phosphate, dipotassium phosphate, tetrapotassium pyrophosphate, ammonium phosphate, calcium phosphate, and combinations thereof.

20. The fertilizer composition of claim 17 wherein the carboxylic acid salt of potassium is selected from (1) HCOOK, or (2) CH₃(CH₂)ₓCOOK wherein x=0-4, or (3) MOOC(CR¹R²)ₓCOOK wherein R¹=—H or —OH or —COOM and R²═—H or —OH or —COOM and x=0-4 and M=H or K, or (4) HO(CR¹R²)ₓCOOK wherein R¹═H or a C1 to C4 alkyl group and R²═H or a C1 to C4 alkyl group and x=1-5, or (5) CH₃CO(CR¹R²)ₓCOOK wherein R¹═H or a C1 to C4 alkyl group and R²═H or a C1 to C4 alkyl group and x=1-3.
